(19) United States
(12) Patent Application Publication
(10) Pub. No.: US 2019/0077988 A1
(43) Pub. Date: Mar. 14, 2019

(54) A POLYSILOXANE HYDROPHOBIC COATING MATERIAL

(71) Applicant: AGENCY FOR SCIENCE, TECHNOLOGY AND RESEARCH, Singapore (SG)

(72) Inventors: Hong YAN, Singapore (SG); Jianwei XU, Singapore (SG)

(21) Appl. No.: 16/083,881

(22) PCT Filed: Mar. 10, 2017
(86) PCT No.: PCT/SG2017/050121

§ 371 Date: Sep. 10, 2018

(30) Foreign Application Priority Data
Mar. 10, 2016 (SG) 10201601877Y

(51) Int. Cl. C09D 183/04; C09D 7/63; D06M 15/643

(52) U.S. Cl. CPC C09D 183/04; C08K 5/11; D06M 15/643; C09D 7/63

(57) ABSTRACT

The present invention relates to a hydrophobic coating material comprising a plurality of polysiloxanes cross-linked by a cross-linker having at least one unsaturated functional group, a process for preparing said coating, a coated article as well as a process for coating said article. The coating material is prepared by reacting the plurality of polysiloxanes with the cross-linker in the presence of a catalyst. In a preferred embodiment, the unsaturated group of the cross-linker is a vinyl, methacrylate or acrylate group, such as pentaerythitol tetramethacrylate. The coated article may be a fabric.

### TECHNICAL FIELD

The present invention generally relates to a coating material and a process for preparing the same. The present invention also relates to a hydrophobic coated article comprising said coating material and a process for forming the same.

### BACKGROUND ART

Superhydrophobic coatings have recently attracted growing research interests owing to their broad spectrum of applications, for example in surgical tools, medical devices, waterproof textiles, maritime industry and for the environmental applications. In order to produce coating materials capable of being used in the aforementioned applications, it is critical to provide further improvement to existing superhydrophobic materials and to the process of making the same in terms of cost, safety and durability. Today, the most effective and general pathway to provide superhydrophobic coating used in the textile industry is using fluorochemicals that are covalently integrated with nanoadditives. However, such fluorochemicals are in general expensive and pose potential risks to human health and to the environment. Therefore, it is highly desirable to develop fluorine-free materials that are less toxic for fabric coating. In addition, as the existing manufacturing process of the superhydrophobic coating materials involves high manufacturing cost with coating materials having low mechanical strength and poor durability, there is a need to develop a new strategy to improve the performance of the fluorine-free materials for fabric coating.

Recent work to improve the performance of coating materials on a substrate has been focused on creating a covalent binding between nanofillers and a polymer matrix. For example, recently copolymerization between a non-fluorinated cross-linker and a fluorinated monomer in the nanofillers affords superhydrophobic films with good durability. The covalent binding efficiently addresses not only the durability of coating materials and thereafter performance of coated substrates as compared to most prevailing blending, but also prevent the nanofillers from self-aggregation and thus promote homogeneous distribution in the polymer networks.

Polyorganosiloxane exhibits desirable properties including its chemical resistance, hydrophobicity, optical transparency, low polarity, non-electrical conductivity and its elasticity. Recently, hybrid coating materials can be produced when the nanofiller such as silica nanoparticles, polyhedral oligomeric silsesquioxane (POSS), carbon nanotube (CNT), graphene oxide (GO), reduced graphene oxide (RGO) and clay is combined with polyorganosiloxane. The coating materials display pronounced superhydrophobicity on textiles and exceptional corrosion resistance. Further, this method allows the surfaces of the nanofillers to be decorated with various targeting polyorganosiloxane matrix. However, such coating materials suffer from poor reproducibility in the preparation of vinyl functionalized nanofillers and tedious synthetic procedures of aryl assisted addition reaction. Further, recent report reveals that the coating materials alter the colour of the textiles (to slightly grey), especially when a high loading of nanofillers CNT, GO and RGO is used.

In the above regard, there is a need to provide a coating material and a process to prepare the same that overcomes, or at least ameliorates, one or more of the disadvantages described above. Further, there is a need to provide a hydrophobic coated article and a process to prepare the same that overcomes, or at least ameliorates, one or more of the disadvantages described above.

### SUMMARY OF INVENTION

According to one aspect, there is provided a coating material comprising a plurality of polysiloxanes cross-linked by a cross-linker having at least one unsaturated functional group.

Advantageously, the coating material described herein may be hydrophobic, may not be toxic to human health or to the environment, stable when exposed to harsh environment (acidic environment, high temperature), durable and display high abrasion resistance. More advantageously, the coating material defined above may be environment-friendly as it is fluorine-free. Yet advantageously, the coating material can be dispersed into many solvents to form a coating solution for further use. The coating material may not be a fluorinated nanoadditive.

In another aspect, there is provided a process of preparing a coating material comprising the step of reacting a plurality of polysiloxanes with a cross-linker having at least one unsaturated functional group in the presence of a catalyst to form a cross-linked polysiloxane.

Advantageously, the process for preparing the coating material described herein may be scalable and it may avoid the complicated reaction steps. Yet advantageously, the process to prepare the coating material described herein may avoid the use of any nanoadditives.

In another aspect, there is provided a hydrophobic coated article comprising a superhydrophobic coating material comprising a layer of a coating material, wherein the coating material comprises a plurality of polysiloxanes cross-linked by a cross-linker having at least one unsaturated functional group.

In another aspect, there is provided a process of forming a hydrophobic coated article comprising the step of contacting an article with a coating material, wherein said coating material comprises a plurality of polysiloxanes cross-linked by a cross-linker having at least one unsaturated functional group.

Advantageously, the coating material described herein may be dispersed in a solvent to form a coating solution that can be directly applied onto an article for example fabrics using a suitable coating technique to form a hydrophobic coated article described above. Yet advantageously, the hydrophobic coated article may be prepared using a single-step coating procedure. Further advantageously, when the coating material is applied onto the fabrics, the coated fabrics may maintain their original color.

Definitions

In the present disclosure, a number of terms are used which are well known to a skilled addressee. Nevertheless, for the purposes of clarity, a number of terms will be defined. The following words and terms used herein shall have the meaning indicated:

The term “cross-linking” refers to forming covalent bonds or crosslinks between polymers, for e.g., linear polymers, branched polymers, dendrimers, or macromolecular molecules. Here, the cross-linking may also refer to covalent bonds or crosslinks between a molecule and a polymer. The term “cross-linker” or “cross-linking agent” refers to a compound or a mixture of compounds capable of forming crosslinks in such a context.

The term “unsaturated functional group” used throughout this disclosure refers to a functional group having an unsaturated bond.

The term ‘solvent’ is to be defined herein as any substance, which upon addition to a composition increases the solubility of parts of the composition, without participating in the reaction process as a reactive partner or part of the catalyst system, i.e. there are no reaction products containing parts of the solvent.

The term “ligand” as used herein, refers to an ion or a molecule capable binding to a central metal catalyst to form a coordination complex. The bonding with the metal generally involves donation of one or more electron pairs of the ligands.

In the definitions of a number of substituents below it is stated that “the group may be a terminal group or a bridging group”. This is intended to signify that the use of the term is intended to encompass the situation where the group is a linker between two other portions of the molecule as well as where it is a terminal moiety. Using the term alkyl as an example, some publications would use the term “alkylene” for a bridging group and hence in these other publications there is a distinction between the terms “alkyl” (terminal group) and “alkylene” (bridging group). In the present application, unless specifically stated as such, most groups may be either a bridging group or a terminal group.

“Alkenyl” as a group or part of a group denotes an aliphatic hydrocarbon group containing at least one carbon-carbon double bond and which may be straight or branched preferably having 2-12 carbon atoms, more preferably 2-10 carbon atoms, most preferably 2-6 carbon atoms, in the normal chain. The group may contain a plurality of double bonds in the normal chain and the orientation about each is independently E or Z. Exemplary alkenyl groups include, but are not limited to, ethenyl, propenyl, butenyl, pentenyl, hexenyl, heptenyl, octenyl and nonenyl. The group may be a terminal group or a bridging group.

“Alkyl” as a group or part of a group refers to a straight or branched aliphatic hydrocarbon group, preferably a C₁-C₁₂ alkyl, more preferably a C₁-C₁₀ alkyl, most preferably C₁-C₆ unless otherwise noted. Examples of suitable straight and branched C₁-C₆ alkyl substituents include methyl, ethyl, n-propyl, 2-propyl, n-butyl, sec-butyl, t-butyl, hexyl, and the like. The group may be a terminal group or a bridging group.

“Alkyloxy” refers to an alkyl-O— group in which alkyl is as defined herein. Preferably the alkyloxy is a C₁-C₆alkyloxy. Examples include, but are not limited to, methoxy and ethoxy. The group may be a terminal group or a bridging group.

“Alkynyl” as a group or part of a group means an aliphatic hydrocarbon group containing a carbon-carbon triple bond and which may be straight or branched preferably having from 2-12 carbon atoms, more preferably 2-10 carbon atoms, more preferably 2-6 carbon atoms in the normal chain. Exemplary structures include, but are not limited to, ethynyl and propynyl. The group may be a terminal group or a bridging group.

“Aryl” as a group or part of a group denotes (i) an optionally substituted monocyclic, or fused polycyclic, aromatic carbocycle (ring structure having ring atoms that are all carbon) preferably having from 5 to 12 atoms per ring. Examples of aryl groups include phenyl, naphthyl, and the like; (ii) an optionally substituted partially saturated bicyclic aromatic carbocyclic moiety in which a phenyl and a C₅₋₇ cycloalkyl or C₅₋₇ cycloalkenyl group are fused together to form a cyclic structure, such as tetrahydronaphthyl, indenyl or indanyl. The group may be a terminal group or a bridging group. Typically an aryl group is a C₆-C₁₈ aryl group.

“Arylalkenyl” means an aryl-alkenyl-group in which the aryl and alkenyl are as defined herein. Exemplary arylalkenyl groups include phenylallyl. The group may be a terminal group or a bridging group. If the group is a terminal group it is bonded to the remainder of the molecule through the alkenyl group.

“Arylalkyl” means an aryl-alkyl-group in which the aryl and alkyl moieties are as defined herein. Preferred arylalkyl groups contain a C₁₋₅ alkyl moiety. Exemplary arylalkyl groups include benzyl, phenethyl, 1-naphthalenemethyl and 2-naphthalenemethyl. The group may be a terminal group or a bridging group. If the group is a terminal group it is bonded to the remainder of the molecule through the alkyl group.

“Arylalkyloxy” refers to an aryl-alkyl-O— group in which the alkyl and aryl are as defined herein. The group may be a terminal group or a bridging group. If the group is a terminal group it is bonded to the remainder of the molecule through the oxygen atom.

“Aryloxy” refers to an aryl-O— group in which the aryl is as defined herein. Preferably the aryloxy is a C₆-C₁₈aryloxy, more preferably a C₆-C₁₀aryloxy. The group may be a terminal group or a bridging group. If the group is a terminal group it is bonded to the remainder of the molecule through the oxygen atom.

A “bond” is a linkage between atoms in a compound or molecule. The bond may be a single bond, a double bond, or a triple bond.

“Cycloalkyl” refers to a saturated monocyclic or fused or spiro polycyclic, carbocycle preferably containing from 3 to 9 carbons per ring, such as cyclopropyl, cyclobutyl, cyclopentyl, cyclohexyl and the like, unless otherwise specified. It includes monocyclic systems such as cyclopropyl and cyclohexyl, bicyclic systems such as decalin, and polycyclic systems such as adamantane. A cycloalkyl group typically is a C₃-C₁₂ alkyl group. The group may be a terminal group or a bridging group.

“Lower alkyl” as a group means unless otherwise specified, an aliphatic hydrocarbon group which may be straight or branched having 1 to 6 carbon atoms in the chain, more preferably 1 to 4 carbons such as methyl, ethyl, propyl (n-propyl or isopropyl) or butyl (n-butyl, isobutyl or tertiary-butyl). The group may be a terminal group or a bridging group.

The term “isomer” as used herein, refers to a compound having the identical chemical formula but different structural or optical configurations.

The term “optionally substituted” as used herein means the group to which this term refers may be unsubstituted, or may be substituted with one or more groups independently selected from alkyl, alkenyl, alkynyl, cycloalkyl, alkyloxy, arylalkyloxy, aryloxy, aryl, arylalkenyl, arylalkyl, alkylaryl.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a coating material, will now be disclosed.

Disclosed herein is a coating material comprising a plurality of polysiloxanes cross-linked by a cross-linker having at least one unsaturated functional group. The plurality of polysiloxanes may be a polyorganosiloxane. The polyorganosiloxane may comprise at least one monomer of the following formula (I)

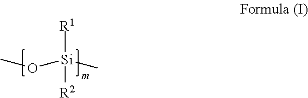

wherein

m is an integer that may be in the range of 10 to 200, 10 to 50, 10 to 100, 10 to 150, 20 to 50, 20 to 100, 20 to 150, 20 to 200, 30 to 50, 30 to 100, 30 to 150, 30 to 200, 40 to 100, 40 to 150, 40 to 200, 50 to 100, 50 to 150, 50 to 200, or 100 to 200. Preferably, m may be in the range of 20 to 60. More preferably, m may be in the range of 26 to 51;

each R¹ is independently selected from hydrogen, an optionally substituted alkyl or an optionally substituted aryl;

each R² is independently selected from hydrogen, an optionally substituted alkyl or an optionally substituted aryl; and

wherein at least one R² in the polyorganosiloxane is hydrogen. Non limiting examples of polyorganosiloxane include polymethylhydrosiloxane (PMHS), polyethylhydrosiloxane (PEHS), polydimethylsiloxane (PDMS), polydiethylsiloxane, poly(dimethylsiloxane-co-methylhydrosiloxane) (PDMS/PMHS), poly(methylhydrosiloxane-co-methylphenylsiloxane) and poly(dimethylsiloxane-co-hydrophenylsiloxane) and combinations thereof. In a preferred embodiment, the polysiloxane is polymethylhydrosiloxane (PMHS).

The average molecular weight (Mn) of the polyorganosiloxane described herein may be in the range of about 500 to about 20,000, about 500 to about 5,000, about 500 to about 10,000, about 1,000 to about 5,000, about 1,000 to about 10,000, about 1,000 to about 20,000, about 1,500 to about 5,000, about 1,500 to about 10,000, about 1,500 to about 20,000, about 2,000 to about 5,000, about 2,000 to about 10,000, about 2,000 to about 20,000, about 3,000 to about 5,000, about 3,000 to about 10,000, about 3,000 to about 20,000, about 5,000 to about 10,000, about 5,000 to about 20,000, about 10,000 to about 20,000, about 15,000 to about 20,000, or about 18,000 to about 20,000. Preferably, the average molecular weight (Mn) of the polyorganosiloxane described herein may be in the range of about 1,000 to about 4,000 or about 1,500 to about 3,500. More preferably, the average molecular weight (Mn) of the polyorganosiloxane described herein may be in the range of about 1,700 to about 3,200. In an embodiment, when poly(dimethylsiloxane-co-methylhydrosiloxane with trimethylsilyl as the terminal group is used, the average molecular weight is about 13,000, (3-4 mol % of methylhydrosiloxane). In a further embodiment when poly(methylhydrosiloxane) is used, the average molecular weight is in the range of about 1,700 to about 3,200.

The cross-linker as described herein comprises at least one unsaturated group, wherein at least one unsaturated group is provided in the terminal position of the cross-linker. The cross-linker may have 1, 2, 3, 4, 5, 6, 7 or 8 unsaturated group(s) in the terminal position of the cross-linker. When the cross-linker is a polymer, the unsaturated group(s) may be located at the side chain and therefore the unsaturated group(s) may be in the terminal position of the side chain. The cross-linker may be of linear or branched polymer where the unsaturated group(s) is/are always located in the terminal position of the linear or branched polymer. In an embodiment, the unsaturated group may be an alkene, an alkyne, an aldehyde or a ketone terminal group. The unsaturated group may be optionally substituted vinyl-, methacrylate and acrylate group. When the unsaturated groups are vinyl-, methacrylate and acrylate, the structure of the cross-linker is shown in Scheme 1. n has a value of above 2, therefore n may be 3, 4, 5, 6, 7, 8, 9, 10, or more.

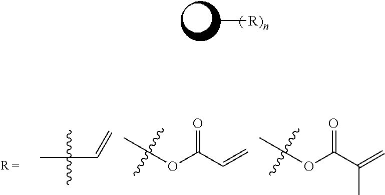

Scheme 1. Representation of vinyl-, methacrylate and acrylate-based (where R denotes vinyl-, methacrylate and acrylate group optionally substituted) cross-linker with n value of above 2.

In an embodiment, non-limiting examples of a suitable functional group terminated cross-linkers include pentaerythritol tetramethacrylate, pentaerythritol triacrylate, pentaerythritol tetraacrylate, 2,4,6-triallyloxy-1,3,5-triazine, 1,3,5-triacryloylhexahydro-1,3,5-triazine, 1,3,5-triallyl-1,3,5-triazine-2,4,6(1H,3H,5H)-trione, trimethylolpropane diallyl ether, allyl ether, diallyl maleate, diallyl carbonate, pentaerythritol allyl ether, 1,2,4-trivinylcyclohexane, tetravinyltin, diallyldimethylsilane, 1,5-hexadiene, 2,2′-diallyl bisphenol A, 2,2′-diallyl bisphenol A diacetate ether, diallyl polycarbonate, 1,1,2,2-tetrakis(allyloxy)ethane, trimethylolpropane triacrylate, trimethylolpropane ethoxylate triacrylate, dipentaerythritol penta/hexa-acrylate, di(trimethylolpropane) tetraacrylate and tetravinyl tin. Here, the isomers of the cross-linkers, whenever applicable, may also be used as the cross-linker for cross-linking with the polysiloxane.

Multiple reaction sites on both polyorganosiloxane and the cross-linker offer strong covalent linkages between the olyorganosiloxaneand the cross-linker.

Exemplary, non-limiting embodiments of a process for preparing a coating material will now be disclosed.

Advantageously, the process described herein may be conducted in one step, and therefore is termed as one-pot process/reaction.

Disclosed herein is a process of preparing a coating material comprising the step of reacting a plurality of polysiloxanes with a cross-linker having at least one unsaturated functional group in the presence of a catalyst to form a cross-linked polysiloxane.

The polysiloxanes used in the reaction may be dissolved in a suitable organic solvent. Non-limiting examples of the organic solvent include toluene, isopropyl alcohol, acetone, hexane, tetrahydrofuran, dimethylsulfoxide (DMSO), dimethylformamide (DMF), and benzene. In an embodiment, the suitable organic solvent to dissolve the polysiloxanes is toluene. When polymethylhydrosiloxane (PMHS) is used as the polysiloxanes, PMHS may be dissolved in toluene to form PMHS solution. The dissolution of the polysiloxanes may be facilitated, when applicable, by common techniques used in the laboratory such as heating and sonicating the polysiloxanes in the solution to form a homogeneous solution.

The next step of the process described herein is to add a cross-linker to the solution of the polysiloxanes. The addition of the cross-linker may be conducted under inert condition such as inert atmosphere. To achieve an inert atmosphere environment, a continuous flow of inert gas such as argon, helium or nitrogen may be used.

In an embodiment, the cross-linker is added to the solution of the polysiloxanes under nitrogen to form a mixture. The resulting mixture may be in the form of a suspension or homogeneous solution. The mixture is then heated at the prescribed reaction temperature in the range of about 60° C. to about 120° C., 60° C. to about 70° C., 60° C. to about 80° C., 60° C. to about 90° C., 60° C. to about 100° C., 60° C. to about 110° C., 70° C. to about 80° C., 70° C. to about 90° C., 70° C. to about 100° C., 70° C. to about 120° C., 80° C. to about 100° C., 80° C. to about 120° C., 90° C. to about 100° C., 90° C. to about 120° C., or 100° C. to about 120° C. under continuous stirring. In an embodiment, the resulting mixture is heated at the prescribed reaction temperature of 80° C. under continuous stirring.

The reaction described above occurs in the presence of a suitable catalyst that is added to the mixture above. The catalyst used for the reaction may be selected from a transition metal-containing catalyst such as platinum, palladium, nickel, rhodium, ruthenium or mixture thereof.

The transition metal-containing catalyst used in the process described herein may be in the form of a coordination complex and therefore the catalyst may contain ligand(s) to form a coordination complex. In an embodiment, the cross-linker as defined herein may be used as the ligand to form a coordination complex. In a further embodiment, a platinum compound such as Speier's catalyst or an organoplatinum compound derived from divinyl-containing disiloxane such as Karstedt's catalyst may be used as the coordination complex. In a preferred embodiment, the coordination complex is platinum(0)-1,3-divinyl-1,1,3,3-tetramethyl disiloxane. Other coordination complex such as rhodium-based and ruthenium-based complexes may also be used. Non-limiting examples of rhodium-based complex include [Rh(cod)₂]BF₄ and [Rh(nbd)Cl]₂. Non-limiting examples of ruthenium-based complex include Wilkinson's catalyst, Grubbs' 1^{st} generation catalyst, [Ru(benzene)Cl₂]₂ or [Ru(p-cymene)Cl₂]₂), [Cp*Ru(MeCN)₃]PF₆.

The amount of the catalyst added in the process above is in the range of about 0.1 wt % to about 1 wt %, about 0.2 wt % to about 1 wt %, about 0.5 wt % to about 1 wt % or about 0.8 wt % to about 1 wt % and is determined by the identity of the cross-linker.

Prior to adding the catalyst to the heated mixture, the catalyst may be dissolved in a solvent for example organic solvent. In an embodiment, the catalyst is dissolved in a minimum amount of organic solvent of about 0.5 mL, about 0.6 mL, about 0.7 mL, about 0.8 mL, about 0.9 mL, or about 1 mLand is then added slowly to the heated mixture. Once, the addition is completed, the reaction mixture is maintained at the prescribed reaction temperature above for about 1 hour, about 2 hours, about 3 hours, about 4 hours, about 5 hours, or about 6 hours.

At the end of the reaction, the reaction mixture may be cooled down to room temperature and may be diluted in a suitable solvent for further use. The suitable solvent used herein is preferably the same as the solvent used in the reaction described above.

The process described above may involve a hydrosilylation reaction, where the addition of Si—H bonds occurs across the unsaturated bonds. The non-limiting examples of the unsaturated bonds-containing functional group include alkene, alkyne, vinyl silane, aldehyde and ketone. In this hydrosilylation reaction, a Speier's and/ or Karstedt's catalyst may be used. When pentaerythritol triacrylate (PT) is used as the cross-linker for cross-linking with polymethylhydrosiloxane (PMHS) of average molecular weight from about 1,700 to about 3,200, the resulting coating material is termed as PMHS @PT. As described above, other polyorganosilanes may be used to undergo a cross-linking process with a cross-linking agent; when poly(dimethylsiloxane-co-methylhydrosiloxane is used, it has trimethylsilyl as a terminal group with the average molecular weight (Mn) of about 13,000 and with methylhydrosiloxane content of 3-4 mol %.

The schematic representation of the process described herein is depicted in Scheme 2.

Scheme 2. Covalent cross-linking between the polysiloxane such as PMHS and the cross-linker via hydrosilylation reaction.

Exemplary, non-limiting embodiments of an article comprising a superhydrophobic coating material, will now be disclosed.

Described herein is a coated article comprising a layer of a coating material, wherein the coating material comprises a plurality of polysiloxanes cross-linked by a cross-linker having at least one unsaturated functional group. The article may be fabrics such as woven, non-woven, knitted fabrics, netting fabrics, or technical fabrics of various materials for example wool, flax, polyester, cotton, asbestos, nylon, canvas and glass fiber.

The coated article may have a water contact angle of at least about 90°, about 100°, about 110°, about 120°, about 130°, about 140°, or about 150°.

In an embodiment, there is provided a process of forming a hydrophobic coated article comprising the step of contacting an article with a coating material, wherein said coating material comprises a plurality of polysiloxanes cross-linked by a cross-linker having at least one unsaturated functional group.

The coating material as defined above may be coated or applied onto the surface of the article using a suitable coating technique. Non-limiting examples of the coating technique include immersing, dip coating and spray coating. The final stage of the coating process to form a hydrophobic coated article may involve a drying or curing process of the article described above at the temperature of about 50° C. to about 100° C., 50° C. to about 80° C., about 60° C. to about 80° C., about 60° C. to about 100° C., about 70° C. to about 100° C., about 80° C. to about 100° C., or about 90° C. to about 100° C. for the duration of about 30 minutes, 45 minutes, 60 minutes, 75 minutes, 90 minutes or 120 minutes. The temperature and duration for drying or curing of said article may be determined by the nature of the substrate and the dimensions such as thickness. In an embodiment, a preferred drying or curing temperature is about 60° C.

### BRIEF DESCRIPTION OF DRAWINGS

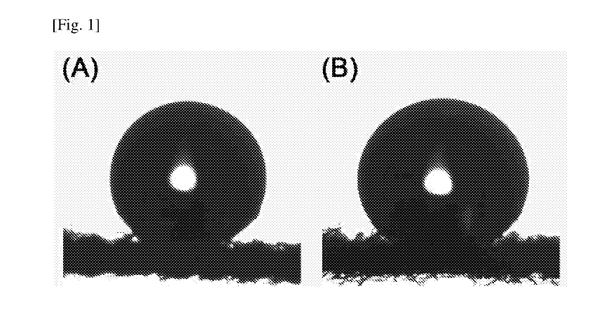

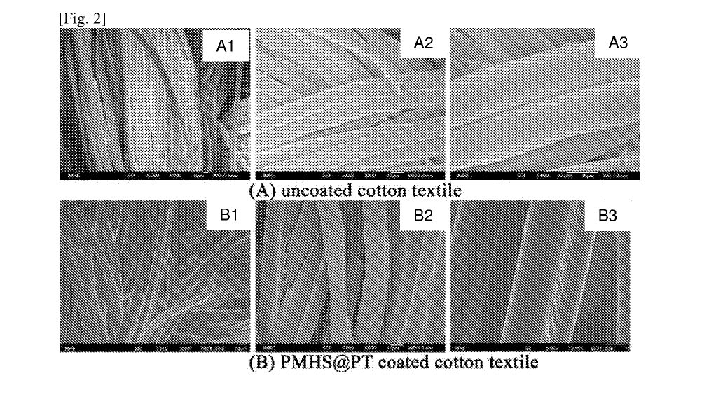

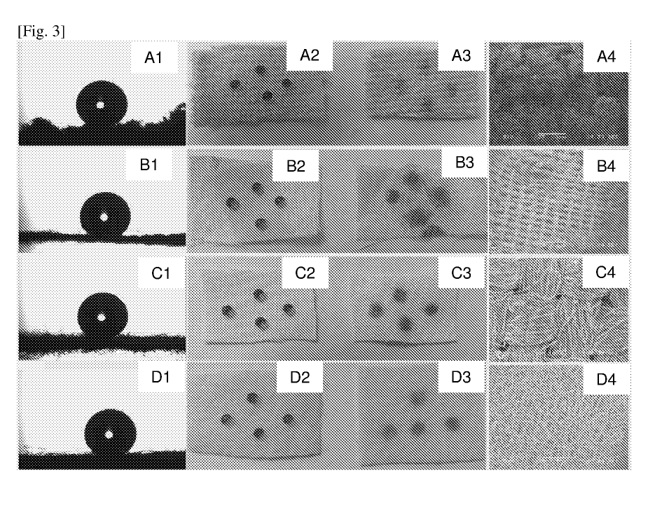

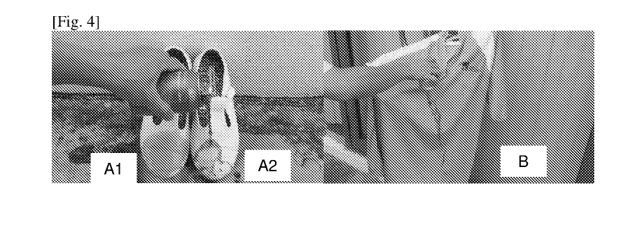

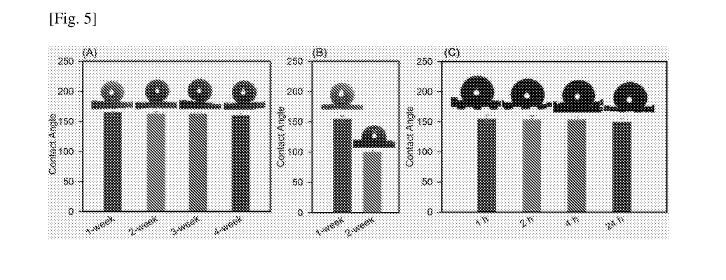

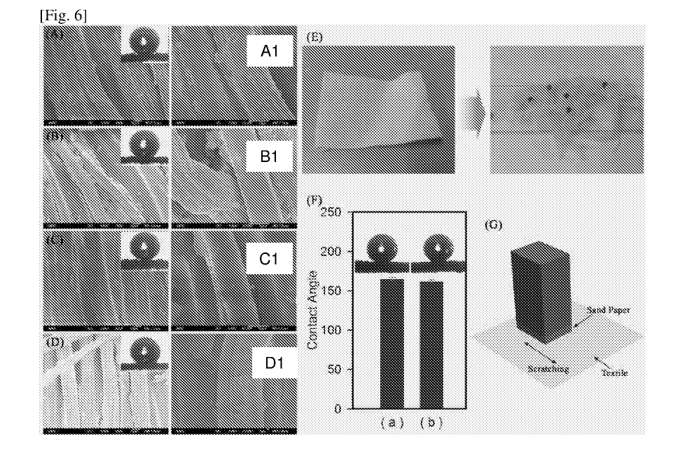

The accompanying drawings illustrate a disclosed embodiment and serves to explain the principles of the disclosed embodiment. It is to be understood, however, that the drawings are designed for purposes of illustration only, and not as a definition of the limits of the invention.

[FIG. 1] refers to photographic images showing the wetting behavior of the water droplets on the PMHS @PT-coated cotton fabrics in (A) ethanol, with water contact angle of about 165° and (B) isopropyl alcohol, with water contact angle of about 155°

[FIG. 2] refers to a number of scanning electron microscope (SEM) images of uncoated cotton textile with a magnification of 300 times, 800 times and 2,000 times, respectively (A1, A2 and A3) and PMHS @PT-coated cotton textile with a magnification of 300 times, 800 times and 2,000 times, respectively (B1, B2 and B3).

[FIG. 3] refer to a number of photographic images showing the wetting behavior of water droplets on the PMHS @PT-coated various commercial textiles, (A1) 100% cotton, (B1) 65% polyester and 35% cotton, (C1) 85% polyester and 15% nylon, and (D1) 100% polyester; FIG. 3 (A2-D2) refer to a number of photographic images showing the wetting behavior on the surface of the PMHS @PT-coated (A2) 100% cotton, (B2) 65% polyester and 35% cotton, (C2) 85% polyester and 15% nylon, and (D2) 100% polyester; FIGS. 3 (A3-D3) refer to a number of photographic images showing the wetting behavior on the surface of the uncoated (A3) 100% cotton, (B3) 65% polyester and 35% cotton, (C3) 85% polyester and 15% nylon, and (D3) 100% polyester; FIG. 3 (A4-D4) refer to a number of SEM images of PMHS @PT-coated (A4) 100% cotton, with a magnification of 25 times, (B4) 65% polyester and 35% cotton, with a magnification of 10 times, (C4) 85% polyester and 15% nylon, with a magnification of 100 times, and (D4) 100% polyester, with a magnification of 20 times.

[FIG. 4] refer to a number of photographic images showing the stain resistant behavior of shoes (A1. uncoated and A2. coated with PMHS @PT) and (B) T-shirt coated with PMHS @PT.

[FIG. 5] refer to a number of graphs showing the water contact angles of PMHS @PT-coated textile changes with various etching time periods in (A) an aqueous H₂SO₄ solution of pH 1; (B) an aqueous solution of KOH of pH 14 and (C) water contact angles of PMHS @PT coated on glass fibers changes with heat at 300° C. for various time periods.

[FIG. 6] refer to (A-D) the SEM images with a magnification of 300 times, showing the morphology changes on the PMHS @PT-coated cotton textile after washing for 1, 2, 5 and 7 days, respectively. (inset: the wetting behavior of water droplets and all the water contact angles are above 150°.); (A1-D1) the SEM images with a magnification of 800 times, showing the morphology changes on the PMHS @PT-coated cotton textile after washing for 1, 2, 5 and 7 days, respectively.; (E) Photographic images of neat PMHS @PT coated cotton textile that was washed to fibers, which the water droplets were also formed on the surface; (F) Graph showing the results of the Scratch test: (a) 5 kPa; (b) 10 kPa; (G) Schematic illustration of the scratch test used to evaluate the mechanical durability of the PMHS @PT coated textile (inset: wetting behavior of water drop on PMHS @PT coated cotton textile after scratch test).

### EXAMPLES

Non-limiting examples of the invention will be further described in greater detail by reference to specific Examples, which should not be construed as in any way limiting the scope of the invention.

### Example 1

### Preparation of Superhydrophobic Coating Materials

6 grams of polyorganosiloxane (such as poly(dimethylsiloxane-co-methylhydrosiloxane), (trimethylsilyl terminated with the average molecular weight (Mn) of about 13,000, and 3-4 mol % of methylhydrosiloxane), or poly(methylhydrosiloxane) with the average molecular weight (Mn) of about 1,700 to about 3,200, both purchased from Sigma-Aldrich of St. Louis, Mo., United States of America) was dissolved in toluene (purchased from Sigma-Aldrich of St. Louis, Mo., United States of America) to form a first solution. 30 mg of vinyl-terminated linear or branched molecules or polymers (for example pentaerythritol tetraacrylate, purchased from Sigma-Aldrich of St. Louis, Mo., United States of America) was then added to the solution obtained in the previous step under nitrogen to afford a suspension. The resulting suspension was then heated at 80° C. under continuous stirring. A 50-mL solution of platinum(0)-1,3-divinyl-1,1,3,3-tetramethyl-disiloxane complex (purchased from Sigma-Aldrich of St. Louis, Mo., United States of America and used as received) was dissolved in about 0.5 to about 1 mL of toluene to form a second solution. The resulting second solution was added slowly to the suspension above to afford a third solution. Once the addition was complete, the third solution was stirred at 80° C. for four hours. The final solution was then diluted and ready for further use.

Superhydrophobic coating materials prepared according to the method above can be dispersed into solvent other than the solvent used for the reaction to form a coating solution for fabric coating. The coating can be directly applied onto the fabrics using dip coating or spray coating and then place the coated textiles into the oven to allow the drying process at 50° C. for one hour. The properties of the superhydrophobic coating materials were evaluated according to various methods outlined below.

Wetting Behaviour of Water Droplets on the Superhydrophobic Material-Coated Cotton Fabrics

Here, the contact angle measurements were carried out on a ramé-hart contact angle goniometer using liquid droplets of 5 μL in volume. Cotton fabrics coated with superhydrophobic coating materials show a nearly-sphere like water droplet as shown in FIG. 1. The average water contact angles on the cotton surfaces coated with PMHS @PT fall in the range of 160 to 170°. 5 μL of the spherical water droplets are stable and they are able to maintain their spherical morphology on the fabrics until they evaporate. However, no contact angle can be observed when pure water was dropped onto the uncoated fabrics, where water completely wets the fabrics. In contrast, a low contact angle of about 60° was observed on pure PMHS -coated fabrics at the same concentration. The results suggest that pentaerythritol triacrylate (PT) cross-linked PMHS plays an essential role in contributing to the formation of superhydrophobic layer on fabrics.

Morphological Evaluations of the Superhydrophobic Coating Materials

The scanning electron microscopy (SEM) images were taken using a JEOL JSM 6700F operated at an acceleration voltage of 5.0 kV. FIG. 2 depicts a representative set of scanning electron microscope (SEM) images of cotton morphology changes before and after coating with various coating materials. The superhydrophobicity trait is qualitatively consistent with the surface morphologies after coating. The uncoated fabrics show a rather rough surface as shown in FIG. 2A in comparison to the PMHS @PT-coated fabrics.

To investigate the coating effect of PMHS @PT on different types of textiles, PMHS @PT was coated on knit, nonwoven and woven textile or polyester, cotton, asbestos, nylon, glass fiber using a spray coating technique. As shown in FIG. 3, the superhydrophobicity was also observed on three different knitting types of textiles. Further observation of FIG. 3 reveals that the knitting pattern of the textile (roughness of the textile) is one of the most important factors that have significant impact on the water contact angles. However, it is noteworthy that the behaviour of the water droplets observed in FIG. 3 is similar to that in FIG. 1. These results are interpreted according to the reported mechanism of lotus leaf. In comparison with the coating on flat surface, the coating materials take advantage of the inherent morphological anisotropy of fabrics which latter provides a hierarchical roughness in the micro scales to further enhance the surface hydrophobicity.

Stain Resistance and Self-cleaning Property

Superhydrophobic coating, in many cases, confers stain resistant and self-cleaning functions to the targeted surface of the substrate. In a different control experiment (FIG. 4A(1) the uncoated surface, FIG. 4A(2) the coated surface and FIG. 4B. T-shirt that has been coated with superhydrophobic material), the objects were flushed with a dye material (in this example Coca-Cola soft drink was used), the surfaces coated with the superhydrophobic material show unwettable and more importantly an excellent stain-resistance.

Stability/Durability Testing

Stability Under Acidic or Basic Conditions

To demonstrate the durability/stability of the coating layer, the PMHS @PT materials for superhydrophobic coating were subjected to a harsh environment such as extreme acidic/basic condition or high temperature and their stability was examined Spherical water droplets with an average contact angle >150° was observed after immersing the coated fabrics in an aqueous H₂SO₄ solution of pH 1 for one month (refer to FIG. 5A). In contrast, the superhydrophobicity was maintained only one week upon treatment with an aqueous KOH solution of pH 14 (refer to FIG. 5B).

Thermal Stability

To assess the thermal stability of the coating materials on textile, glass fiber was used as textile substrate coated with PMHS @PT. It is to be noted that the glass fiber experienced a dramatic change from being hydrophilic before coating to superhydrophobic after coating. Interestingly, upon exposing the coated glass fibers to the heat (300° C.) for 24 hours, no observable change in superamphiphobicity was recorded (refer to FIG. 5C). The results strongly indicate that this type of superhydrophobic coating shows excellent thermal stability at high temperatures.

Mechanical Durability/Stability

Further, the mechanical durability/stability of the superhydrophobic-coated fabric was evaluated using laundry condition in accordance with the procedures described in the American Association of Textile Chemists and Colorists (AATCC) Test Method 61-2006. The test was performed using a standard color-fastness to washing laundering machine (Model SW-12AII, Wenzhou Darong Textile Instrument Co., Ltd of China) equipped with 500 mL (75 mm×125 mm) stainless-steel lever-lock canisters. The fabric was laundered in a rotating closed canister containing 200 mL aqueous solutions of an AATCC standard WOB detergent (0.37%, w/w) and 10 stainless steel balls. The sizes of the fabric samples were 50 mm×100 mm (2.0 in.×4.0 in.) for the experimental test. During laundering, the temperature was maintained at 50° C. with constant stirring speed of 40 rpm. After 45 minutes of laundering, the laundered sample was rinsed with tap water and was then dried at room temperature without spinning. The contact angle was subsequently measured. The standard washing procedure described herein is equivalent to five cycles of home machine launderings. Hence, the equivalent number of home launderings is used in this disclosure.

FIG. 6 shows a set of representative SEM images of the morphology changes of PMHS @PT coated cotton fiber after washing with different number of cycles. While SEM images suggest that the surface morphologies have slightly changed, the water contact angle of the textile fibers coated with PMHS @PT still remained more than about 160° after washing for a week. As can be seen from FIG. 6E, the water marbles were formed even the textile washed as fibres. The results reveal excellent durability of the coating materials on textiles.

Scratch Test

The stability of the coated fabric in the abrasion with sandpaper was examined. The methodology of scratch test is illustrated in FIG. 6G. Sandpaper of 1200 mesh served as an abrasion material, with the coated fabric to be tested facing this abrasion material. While a pressure of 5 kPa (or 10 kPa) was applied to the textile, the sandpaper was moved back and forth with a speed of 0.5 cm/s. The experimental results (refer to FIG. 6F) suggest that the coated fabrics had no change in superhydrophobicity after being abraded repeatedly, where water droplets displayed contact angle above 160°.

### INDUSTRIAL APPLICABILITY

The coating materials described in the present disclosure exhibit superior properties such as hydrophobic, thermally stable, durable, stain-resistant, having self-cleaning property and not toxic to human health or to the environment. Further, the process of manufacturing the coating materials disclosed in the present disclosure is cost-effective as it avoids the use of fluorochemicals. One-step manufacturing technique as described here allows a straightforward scale-up process. Hence, a wider spectrum of applications is envisaged for example as a coating material used in surgical tools, medical devices, waterproof textiles (such as used as materials for sportswear, military clothing, and tents), maritime industry and for environmental applications.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1-20. (canceled)

21. A coating material comprising a plurality of polysiloxanes cross-linked by a cross-linker having at least one unsaturated functional group, wherein the cross-linker is selected from the group consisting of pentaerythritol tetramethacrylate, pentaerythritol triacrylate, pentaerythritol tetraacrylate, 2,4,6-triallyloxy-1,3,5-triazine, 1,3,5-triacryloylhexahydro-1,3,5-triazine, 1,3,5-triallyl-1,3,5-triazine-2,4,6(1H,3H,5H)-trione, trimethylolpropane diallyl ether, allyl ether, diallyl maleate, diallyl carbonate, pentaerythritol allyl ether, 1,2,4-trivinylcyclohexane, tetravinyltin, diallyldimethylsilane, 1,5-hexadiene, 2,2′-diallyl bisphenol A, 2,2′-diallyl bisphenol A diacetate ether, diallyl polycarbonate, 1,1,2,2-tetrakis(allyloxy)ethane, trimethylolpropane ethoxylate triacrylate, dipentaerythritol penta/hexa-acrylate, di(trimethylolpropane) tetraacrylate and tetravinyl tin.

22. The coating material according to claim 21, wherein the polysiloxane is a polyorganosiloxane.

23. The coating material according to claim 22, wherein the polyorganosiloxane comprises at least one monomer of the following formula (I) 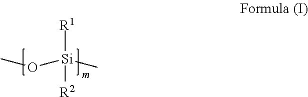
wherein
m is an integer in the range of 10 to 200;
each R¹ is independently selected from hydrogen, an optionally substituted alkyl or an optionally substituted aryl;
each R² is independently selected from hydrogen, an optionally substituted alkyl or an optionally substituted aryl; and
wherein at least one R² in the polyorganosiloxane is hydrogen.

24. The coating material according to claim 23, wherein said polyorganosiloxane is a polyalkylhydrosiloxane or a polydialkylsiloxane.

25. The coating material according to claim 24, wherein said polyorganosiloxane is selected from the group consisting of polymethylhydrosiloxane (PMHS), polyethylhydrosiloxane (PEHS), polydimethylsiloxane (PDMS), polydiethylsiloxane, poly(dimethylsiloxane-co-methylhydrosiloxane) (PDMS/PMHS), poly(methylhydrosiloxane-co-methylphenylsiloxane) and poly(dimethylsiloxane-co-hydrophenylsiloxane).

26. A process of preparing a coating material comprising the step of reacting a plurality of polysiloxanes with a cross-linker having at least one unsaturated functional group in the presence of a catalyst to form a cross-linked polysiloxane, wherein the cross-linker is selected from the group consisting of pentaerythritol tetramethacrylate, pentaerythritol triacrylate, pentaerythritol tetraacrylate, 2,4,6-triallyloxy-1,3,5-triazine, 1,3,5-triacryloylhexahydro-1,3,5-triazine, 1,3,5-triallyl-1,3,5-triazine-2,4,6(1H,3H,5H)-trione, trimethylolpropane diallyl ether, allyl ether, diallyl maleate, diallyl carbonate, pentaerythritol allyl ether, 1,2,4-trivinylcyclohexane, tetravinyltin, diallyldimethylsilane, 1,5-hexadiene, 2,2′-diallyl bisphenol A, 2,2′-diallyl bisphenol A diacetate ether, diallyl polycarbonate, 1,1,2,2-tetrakis(allyloxy)ethane, trimethylolpropane ethoxylate triacrylate, dipentaerythritol penta/hexa-acrylate, di(trimethylolpropane) tetraacrylate and tetravinyl tin.

27. The process according to claim 26, wherein reacting step is undertaken at a reaction temperature in the range of 60° C. to 120° C.

28. The process according to claim 26, wherein the catalyst is a coordination complex.

29. The process according to claim 28, wherein the coordination complex catalyst is Speier's catalyst or Karstedt's catalyst or platinum(0)-1,3-divinyl-1,1,3,3-tetramethyl disiloxane.

30. The process according to claim 28, wherein the catalyst is used at an amount in the range of 0.1 wt % to 1 wt %.

31. A hydrophobic coated article comprising a layer of a coating material, wherein the coating material comprises a plurality of polysiloxanes cross-linked by a cross-linker having at least one unsaturated functional group, and wherein the cross-linker is selected from the group consisting of pentaerythritol tetramethacrylate, pentaerythritol triacrylate, pentaerythritol tetraacrylate, 2,4,6-triallyloxy-1,3,5-triazine, 1,3,5-triacryloylhexahydro-1,3,5-triazine, 1,3,5-triallyl-1,3,5-triazine-2,4,6(1H,3H,5H)-trione, trimethylolpropane diallyl ether, allyl ether, diallyl maleate, diallyl carbonate, pentaerythritol allyl ether, 1,2,4-trivinylcyclohexane, tetravinyltin, diallyldimethylsilane, 1,5-hexadiene, 2,2′-diallyl bisphenol A, 2,2′-diallyl bisphenol A diacetate ether, diallyl polycarbonate, 1,1,2,2-tetrakis(allyloxy)ethane, trimethylolpropane ethoxylate triacrylate, dipentaerythritol penta/hexa-acrylate, di(trimethylolpropane) tetraacrylate and tetravinyl tin.

32. The article according to claim 31, wherein the coated article is a fabric.

33. The article according to claim 31, wherein the coated article has a water contact angle of at least 90°, or at least 150°.

34. A process of forming a hydrophobic coated article comprising the step of contacting an article with a coating material, wherein said coating material comprises a plurality of polysiloxanes cross-linked by a cross-linker having at least one unsaturated functional group, and wherein the cross-linker is selected from the group consisting of pentaerythritol tetramethacrylate, pentaerythritol triacrylate, pentaerythritol tetraacrylate, 2,4,6-triallyloxy-1,3,5-triazine, 1,3,5-triacryloylhexahydro-1,3,5-triazine, 1,3,5-triallyl-1,3,5-triazine-2,4,6(1H,3H,5H)-trione, trimethylolpropane diallyl ether, allyl ether, diallyl maleate, diallyl carbonate, pentaerythritol allyl ether, 1,2,4-trivinylcyclohexane, tetravinyltin, diallyldimethylsilane, 1,5-hexadiene, 2,2′-diallyl bisphenol A, 2,2′-diallyl bisphenol A diacetate ether, diallyl polycarbonate, 1,1,2,2-tetrakis(allyloxy)ethane, trimethylolpropane ethoxylate triacrylate, dipentaerythritol penta/hexa-acrylate, di(trimethylolpropane) tetraacrylate and tetravinyl tin.

35. The process according to claim 34, wherein said contacting step is undertaken via dip coating, spray coating, or immersing the article in a solution of the coating material.
